(19) United States
(12) Patent Application Publication
(10) Pub. No.: US 2016/0325878 A1
(43) Pub. Date: Nov. 10, 2016

(54) PACKAGE MATERIAL BLANK, PACKAGE WITH SUCH DEVICE AND METHOD FOR MANUFACTURING AN OPENING DEVICE

(71) Applicant: TETRA LAVAL HOLDINGS & FINANCE S.A., Pully (CH)

(72) Inventors: Jonas BJÖRK, Lund (SE); Anders DANIELSSON, Hörby (SE)

(73) Assignee: TETRA LAVAL HOLDINGS & FINANCE S.A., Pully (CH)

(21) Appl. No.: 15/109,331

(22) PCT Filed: Dec. 16, 2014
(86) PCT No.: PCT/EP2014/078016

§ 371 Date: Jun. 30, 2016

(30) Foreign Application Priority Data
Dec. 30, 2013 (EP) 13199808.0
May 7, 2014 (SE) 1450541-6
Sep. 11, 2014 (EP) PCT/EP2014/069441

(51) Int. Cl. B65D 5/70; B32B 3/08; B32B 3/26; B32B 15/20; B65D 85/72; B32B 27/10; B32B 27/32; B29C 45/14; B65D 5/06; B65D 5/54; B32B 15/085; B32B 27/08

(52) U.S. Cl. CPC B65D 5/701; B32B 15/085; B32B 3/08; B32B 3/266; B32B 15/20; B32B 27/08; B32B 27/10; B32B 27/32; B29C 45/14344; B65D 5/064; B65D 5/541; B65D 85/72; B32B 2307/31; B32B 2307/7242; B32B 2307/582; B32B 2439/62; B32B 2439/70; B29L 2031/7166

(57) ABSTRACT

A package material blank comprises a plastic opening device, having a first portion on a first side and a second portion on a second side of the package material blank. The portions are connected with each other via a material bridge penetrating the blank. A grip portion is attached to a distal end of the first portion and displaced form the blank to facilitate easy grabbing for a consumer.

The present invention relates to a package material blank and to a package container comprising such blank. The invention also relates to a method for manufacturing an opening device on a package material blank.

### BACKGROUND OF THE INVENTION

Package containers of the single use disposable type for liquid foods are often produced from a packaging material based on paperboard or carton. Such container is for example be employed for aseptic packaging of liquid foods such as milk, fruit juices etc, marketed and sold for long term ambient storage. The packaging material in such package container is typically a laminate comprising a bulk layer of paper or paperboard, outer, liquid-tight layers of thermoplastics, a gas barrier layer, most commonly an aluminum foil and finally one or more inside layers composed of one or several part layers, comprising heat-sealable adhesive polymers and/or heat-sealable polyolefins.

Package containers of this sort are normally produced on fully automatic packaging machines. In one example, a continuous tube is formed from the web-fed packaging material; the web of packaging material is sterilized in the packaging machine, and the sterilized web of packaging material is maintained in a closed, sterile environment in the subsequent step. The web is folded and sealed longitudinally to form a vertical tube. The tube is filled with the sterilized or sterile-processed food product, and is sealed and subsequently cut along equally spaced cross sections to form pillow packs, which are then folded mechanically to form respective finished, e.g. substantially parallelepiped-shaped, package containers.

Commonly, the package container have an opening device in order to facilitate consumer opening, many different types of opening devices including pull-tabs or molded opening devices, as for example discussed in WO03/095199 25 and WO/2009/000927.

However, the latter type of package is a high-volume (in terms of packages per time unit) and low-cost package (due to the properties of the packaging material), and such opening devices might hamper the production speed and be detrimental for the cost of the package.

For this reason there is a need for an opening device having a high efficiency in regard of the amount of material used and the time needed for production of each opening device.

### SUMMARY OF THE INVENTION

For the purpose of the invention, the term “Package material blank” or “blank” shall include an individual sheet or a blank in a package material web. Such package material web may comprise one or more “package material blanks” arranged after each other in a continuous web, some of those blanks in different processing stages, i.e. on one blank in such web may comprise an opening device, while other blanks on the web might still be un-processed.

For the purpose of the invention, the terms container, package and packaging container refer to the same structure. In addition, the terms material, material laminate structure or packaging material refers to the package material blank. The term “cellulosic material” may comprise one or more layers of paper, cardboard or any other cellulosic fiber based material.

In an embodiment of the invention a package material blank comprises a multilayer material structure having a layer of cellulosic material and one or more layers of plastic laminate. The blank comprises a plastic opening device. The plastic opening device contains two portions arranged on different major sides of the blank and connected via a material bridge penetrating through the material structure. While the second portion is of the opening device is attached to one major side or surface of the blank, the first portion comprises a proximal end connected to the material bridge and a distal end displace from the other major side or surface. The opening device further comprises a grip portion for a consumer to grab. The grip portion is attached to the distal end of the first portion and displaced from the surface of the package material blank.

The displacement of the grip from the surface of the package material enables a consumer to easily grab the portion and bend it for opening the package. The grip is rigidly connected via the first portion and the material bridge penetrating through the package material to the second portion. The penetration allows exerting high forces without ripping the grip portion from the bridge or the second portion. The opening device is easy to manufacture, for instance by injection molding or similar techniques and offers a variety of different shapes.

For this purpose, it is proposed to provide a package material blank with a multilayer material structure having a layer of cellulosic material, one or more layers of plastic laminate and a penetration area. A first mold half is arranged on one side of the package material blank later forming an outside of a package container. A second mold half is on the other side of the package material blank. While the second mold half comprises a recess, the first mold half comprises a cavity with an opening facing the package material.

In this respect, the terms cavity and recess are used with different meaning. A cavity is understood to open up in a direction away from its opening, so a cavity may have a significant undercut. In other words, the area of the opening may be much smaller than an area of a cut parallel to the opening and through the cavity. A recess in contrast thereto is normally becoming narrower and does not have a significant undercut.

To create the opening device on the package material structure, a plastic melt is injected into one of the recess and the cavity. Due to pressure being built up in said cavity or said recess, the melt penetrates through penetration area in the package material structure and fills both recess and cavity completely. Particularly the melt forms the material bridge, the first and second portion, and when filling the cavity also the grip portion of the opening device.

In the next step, the cavity is opened up as to release said grip portion, the grip portion is removed from said cavity by a relative movement between the first mold half and the package material blank.

The proposed method provides an opening device having a grip portion which is spaced apart from a surface of packaging material, thereby preventing the grip portion from being attached to the uppermost material layer. The grip portion is released by opening the mold half and more particularly the cavity of the first mold half.

In an embodiment, the opening device is released by moving the second mold half and the package material blank relatively to each other in a direction perpendicular to package material blank. The first mold half is separated into a spacer portion and a recess portion, by moving the recess portion relatively to the package material and the spacer portion in a direction perpendicular to the package material. The spacer portion is arranged between the package material and the grip portion. Then the spacer portion moved relatively to the grip portion in a direction substantially parallel to the packaging material as to withdraw the spacer portion between the grip portion and the packaging material.

Both movement of the spacer portion and the recess portion can partially overlap, when they are performed. For instance the withdrawal can start while the perpendicular movement is still ongoing. The spacer portion provides a displacement of the grip portion from the surface of the package material blank ensuring the grip portion does not attach to the surface of the package material blank during manufacturing of the opening device.

Another aspect is related to the forming of the cavity. For this purpose, a half mold portion having a recess is provided and a spacer portion is arranged such that it partly covers the recess as to form a cavity having an opening. The spacer portion is moved relatively to the recess portion in a direction perpendicular to a plane substantially parallel to a surface of the spacer portion facing the package material until a planar surface is formed.

In subsequent steps the package material blank can be formed into a package container having said opening.

In an aspect of the invention, the grip portion comprises an elongated part, which extends at least partial substantially parallel to the first side. Said elongated part is formed in the cavity and may comprise different shapes, grip features and the like. The parallel arrangement provides some stack ability of packages, particularly if the distance between the package material blank and the grip portion is small and in the range of a few millimeters. The first portion enables to bend the grip portion to adjoin the grip portion to the package material of the container for improved stack-ability.

In an embodiment, a surface of the distal end to which the grip portion is attached to is substantial perpendicular to the package material blank and/or the surface thereof. Hence, the first portion protrudes from the package material blank. In an embodiment, the distal end of the first portion may lie within the penetration area.

The protrusion may follow a curved shape, for example a parabolic, arc-like or circular shape; the focal point of such curved shape may lie in a space between the package material and the grip portion. Alternatively, the protrusion may comprise a ramp like structure, thereby following a substantial linear increase. The exact shape and structure of the protrusion may depend on various circumstances, including but not limited to the forces necessary to open the package material, the shape of the grip portion, size of the bridge, thickness and composition of the penetration area and/or the package material.

Another aspect is related to the penetration area. In an embodiment the size of the penetration area is larger compared to the size of the material bridge penetrating through the material in the penetration area. Such approach reduces the accuracy for positioning the molding parts on the package material when manufacturing the opening device. The penetration area may be attenuated, meaning said area comprises a smaller thickness or another layer composition than the surrounding package material. For example the penetration area may lack one or more layers; particularly it may lack any cardboard, carton or cellulosic layer.

The first portion may be completely arranged inside the penetration area, thereby offering good opening characteristics.

In another aspect, the second portion of the opening device on the other side of the package material blank extends beyond the penetration area. In other words, the area covered by the second portion on the package material blank is larger than the penetration area and thus extends onto the surrounding area of the penetration area as well. This enables high stability and strong attachment to the package material itself withstanding even high forces during opening the package without being torn or pulled off.

To facilitate the opening of the package, the package material blank may comprise in an embodiment a consumer opening area. The consumer area may be separated at least partly from a surrounding area by a line of weakness facilitating the opening. The package material blank is ruptured in a defined manner upon using the plastic opening device to open the consumer opening area. The consumer opening area may also partly comprise the penetration area.

### DESCRIPTION OF THE DRAWING

In the following the present invention will be explained in greater detail using the accompanying drawings, in which

FIG. 1 shows a perspective view of an opening device on a package material according to an embodiment of the present invention;

FIG. 2 illustrates the bottom view of the embodiment according to FIG. 1;

FIG. 3 illustrates a cut-view of the embodiment of FIG. 1;

FIG. 4A shows a cut-view of a second embodiment according to the invention;

FIG. 4B shows a cut-view of a third embodiment according to the invention;

FIG. 5 shows a perspective view of a package having an opening device according to the present invention;

FIG. 6 illustrates a cut-view of a molding apparatus for processing package material in accordance with an embodiment of the present invention;

FIG. 7 illustrates an embodiment of method for processing the package material blank.

Same or similar features in the following embodiment bear the same reference signs. The various features of the embodiments can be combined in different ways without deviating from the scope of the invention.

### DETAILED DESCRIPTION

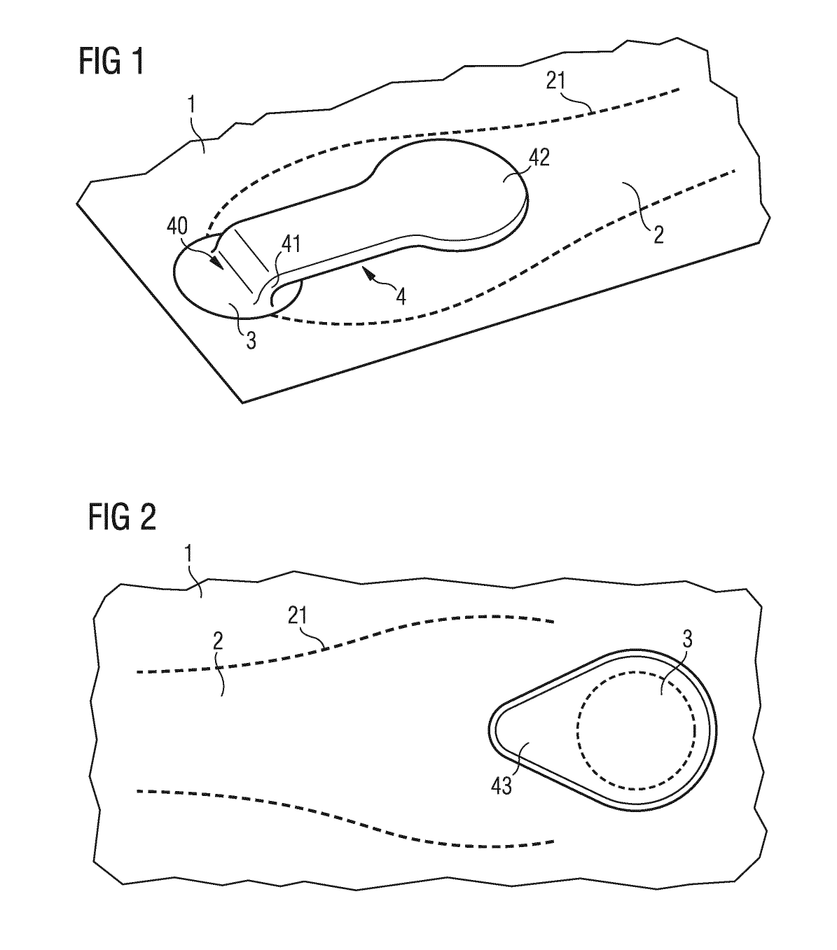

FIG. 1 shows an embodiment of an opening device on a package material. The package material is part of a blank, which may in some embodiment be part of a package material web. However, the blank may also be an individual package material blank. The package material blank 1 comprise a multilayer structure having at least one layer of cellulosic material, including for example carton, cardboard, paper or any other fibre based material. The carton or cardboard layer has a thickness of some hundred μm; the thickness depends on the required stability, type of package, size of package and other parameters. The package material blank also comprises one or more plastic layers on both sides of fiber based layer as well as an aluminum layer on the side facing the food product. The specifications of such material are known to a skilled person.

The package material blank comprises a penetration area 3, which in this case is a circular attenuated area, meaning that it lacks the fiber based layer. Consequently, its thickness is smaller and reduced compared to the surrounding area. Penetration area 3 only comprises one or more plastic layers and an aluminum layer in this embodiment. Adjoining to penetration area 3 is a consumer opening area 2, which is separated partly from other area of the package material blank by lines of weakness 21. The lines of weakness comprise a perforation extending from penetration area 3 for facilitating the rupture of the blank along these lines to open the package. At its distal end the consumer area 2 merges into an area not used for opening the package.

The embodiment of FIG. 1 also comprises an opening device, on which the upper part is shown. The opening device comprises a first portion 41, which protrudes from the penetration area 3 in a shaped manner towards the consumer area 2 and merges at its distal end into a grip portion 42. Grip portion 42 is arranged above consumer area 2 and displaced from the surface of consumer area 2. Hence a small space, mainly provided by the protrusion of first portion 41 above the surface of the package material blank 1, between grip portion 42 and the consumer area 2 is provided. The spacing between the grip portion and the surface of the consumer area 2 prevent the grip portion from being attached to the surface during production. It is also easy for a consumer to grab portion 42 and bend the grip portion upwards. At a proximal end of the first portion, the first portion is connected via a material bridge through the penetration area to a second portion (not shown) attached to the lower side of the package material blank 1.

For opening the opening device, a consumer can grab the grip portion and pull the grip portion towards the consumer opening area. Due to the material bridge and the second portion, the penetration area will rip open. Then the material in the consumer area 2 will substantially rupture along the perforation lines 21.

FIG. 2 is a bottom view of a packaging material blank as described in the embodiment of FIG. 1. This side shown here faces the food product in a later stage, when a container is made from the blank. The opening device comprises the second portion 43, which extends beyond the circular penetration area 3. Second portion 43 is attached to the material of penetration area 3 and partly the surrounding areas including consumer area 2. More particular, the second portion comprises an elongated portion extending into consumer opening area 2. The elongated portion supports opening the package, when a consumer pulls the grip portion towards the consumer opening area 2. Second portion comprises a plastic part made by molding, e.g. injection molding, while the penetration area is hidden behind the plastic part and normally not seen from the inside of the packaging container. The perforation lines may also not visible in all embodiment, e.g. the perforation 21 may only extend into the cellulosic layer and an aluminum foil me be placed on said layer to protect the subsequently filled in food product.

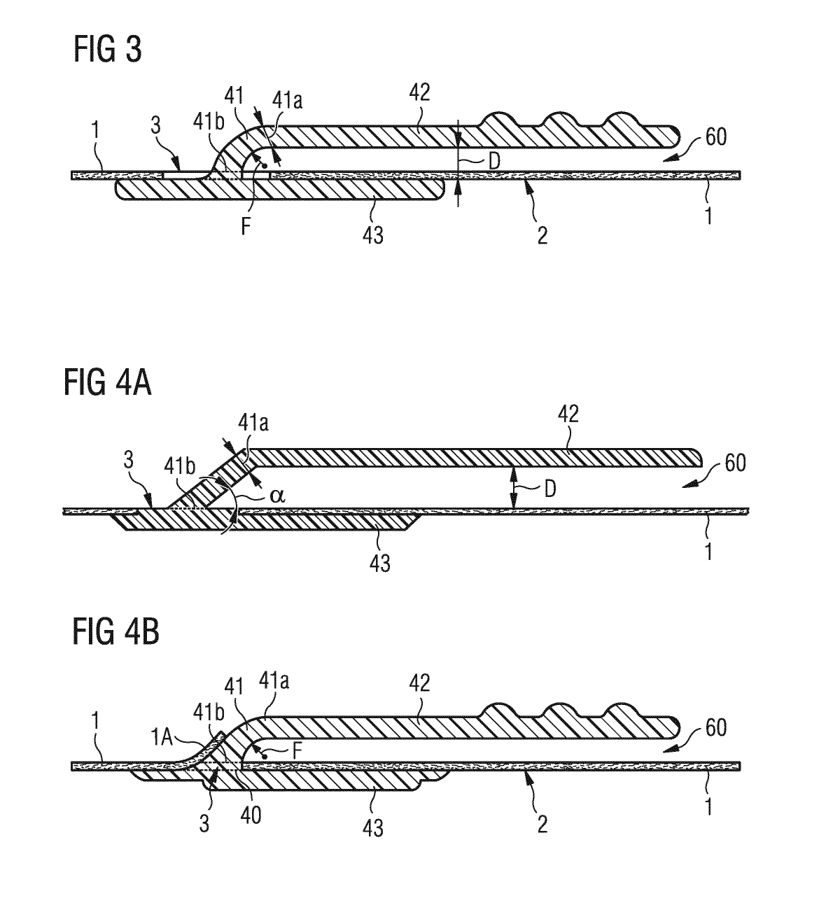

FIG. 3 illustrates the cut-view of the embodiment of FIGS. 1 and 2. The penetration area 3 comprises a smaller thickness than the surrounding area of package material blank 1. The cellulosic layer has been removed and only one or more plastic layers and the aluminum layer remain in penetration area 3. The penetration area 3 is larger than the material bridge 40 of the opening device penetrating area 3.

The material bridge adjoins and connects the first portion 41 with the second portion 43. Second portion 43 does not only cover penetration area 43 completely, but also extends onto the surrounding areas. Second portion is rigidly attached to the package material forming the consumer opening area 2 to prevent the plastic material of the second portion just to be torn of, when a consumer pulls on the grip portion 42. The first portion 41 is attached with its proximal end 41b to the material bridge and with its distal end 41a to the grip portion. As the opening device is made in one piece, e.g. by injection molding, one can say that first portion 41 merges on the one side into the material bridge 40 and on the other side into the grip portion 42. The grip portion 42 is displaced from the surface of blank 1 by a distance D. Said distance can be in the range of some millimeter. It depends on the protrusion of the first portion above the surface of package material blank 1.

In this embodiment first portion comprises a circular shape such that the surface of the distal end 41a is substantial perpendicular to the surface of blank 1. The circular shape can be such that the focal or center point F lies in the space 60 between the grip portion and the surface of the blank 1. Despite the circular shape shown here other shapes, like arcs, parabolic shapes and the like can be used.

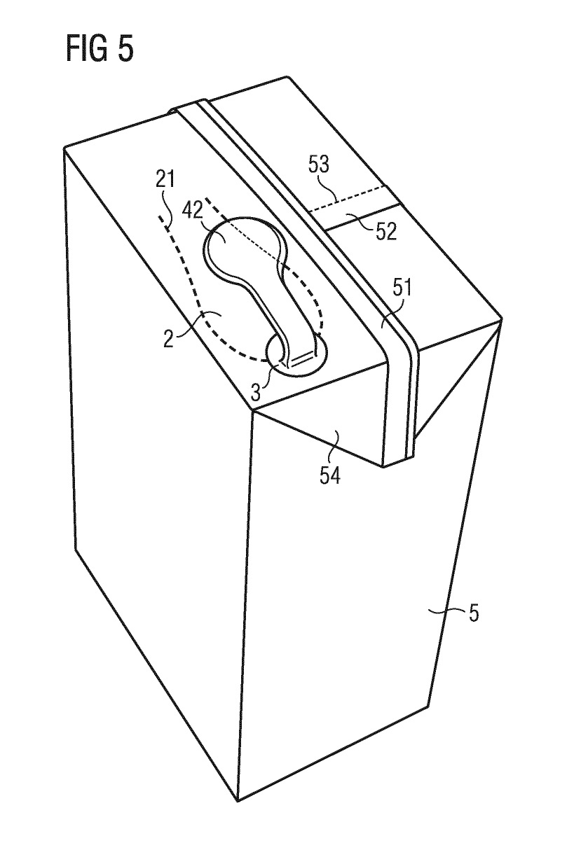

Another alternative of such opening device having a different first portion is shown in FIG. 4A. In this embodiment, the first portion 40 on the proximal end side and the blank or the penetration area 3 forms an angle α smaller than 90°. The first portion protrudes in a linearly increasing way from the level of the package material blank 1 to the distance D at which it merges into the grip portion 42. Consequently, the shape if the first portion is just linearly increasing. The angle α may be about 30° to 45°, depending on the force and other parameter required to provide a good opening. Other values can be chosen as well. The penetration area 3 is a hole through the package material blank 1, which is then completely filled with plastic material forming the bridge.

A slightly alternative embodiment is shown in FIG. 4A. The package material blank 1 is penetrated in the penetration area 3, ripping the material apart and bending a portion 1A of the package material blank upwards attached to the first portion 41. The material bridge 40 is formed by the plastic material filling the space between first and second portion and the package material. Again, the shape of the first portion is curved directed towards the consumer opening area.

FIG. 5 shows an example of a package container 5 produced from the packaging material described in FIG. 1 and which as specified herein has been provided with weakening lines 21 and an attenuation on which an opening device is molded, for example by injection molding.

The grip portion 42 is a part of the opening device which as shown in the previous FIGS. 1 to 3. It also comprises the second portion on the inside of the packaging container connected via the material bridge. The packaging container is particularly suitable for liquid or semi-liquid food products such as beverages, sauces, soups or the like. Typically, such a package has a volume of about 100 ml to 2000 ml. It may be of any configuration such as those described herein, but is for example brick-shaped, comprising longitudinal seal 53, transversal seal 51 and folded flaps 54 on the side. The transversal seal 51 is folded away from the penetration area 3 and the consumer opening area 2. In another embodiment, not shown, the packaging container may be shaped as a wedge. In order to obtain such a “wedge-shape”, only the bottom part of the package is fold formed such that the transversal heat-seal of the bottom is hidden under the triangular corner flaps, which are folded and sealed against the bottom of the package. The top section transversal seal is left unfolded. In this way the half-folded packaging container is still easy to handle and dimensionally stable (i.e. keeps form and shape) when put on a shelf in the food store or on a table or the like.

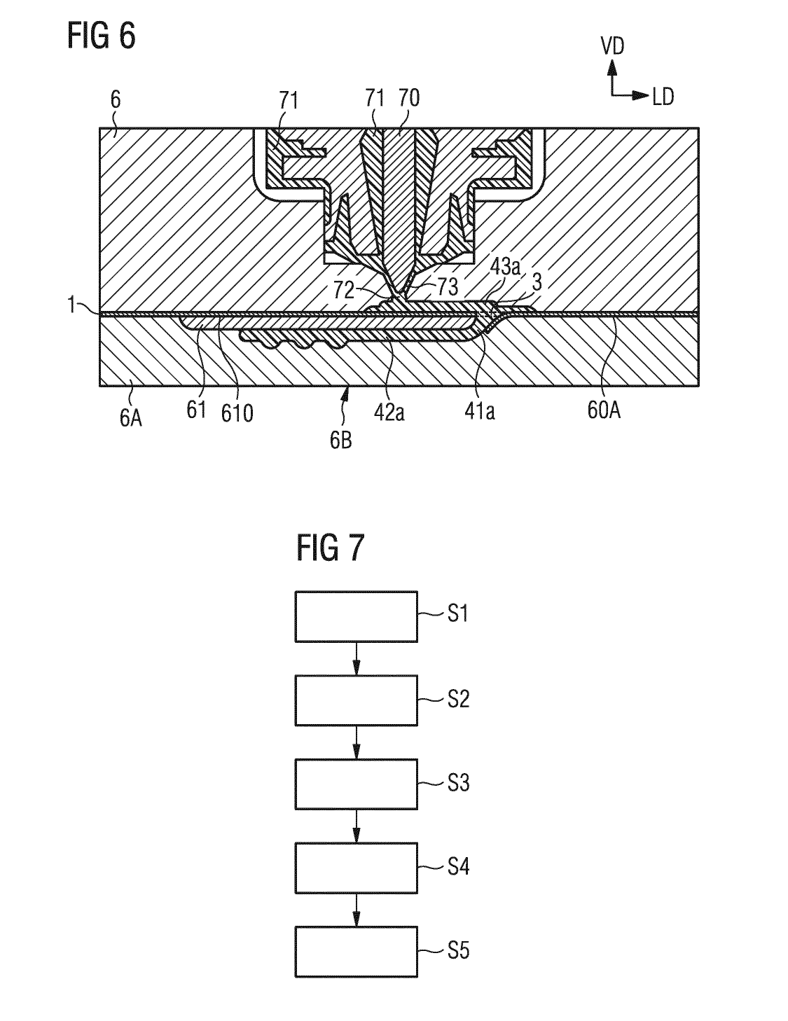

FIG. 6 shows a molding tool for manufacturing the opening device according to the present invention. The molding device comprises a lower or first mold half 6A and an upper or second mold half 6. The second mold half 6 comprises a cone or similar arrangement 70. The cone is retracted to allow molten plastic or hot melt under pressure flowing through channel 73 and nozzle 72 into a recess 43a. Recess 43 is arranged in the lower side facing the package material blank 1. It resembles the structure of the second portion of the opening device. The first mold 6A half is arranged on the other side of the package material blank 1. Mold calf comprises two major portions, a mold portion 6B with a planar surface 60A facing package material blank 1 and a movable spacer 61. The spacer 61 is movable along the vertical direction VD. It is arranged in a recess of mold portion 6B to form a cavity 42a for the grip portion. In other words, spacer 61 covers partly the recess of the mold portion to form cavity 42a. Surface 610 of spacer 61 is coplanar with surface 60A of mold portion 6B.

The spacer 61 extends from one side of the recess to the other side, leaving a small opening space 41a′. Said opening space 41 resembles the first portion, while the cavity is used for molding the grip portion. As illustrated recess 42a is in its lateral dimension significant bigger than opening area 41a′. One can say that a projection of the planar dimension or area of cavity 42a onto the package material is larger than the planar dimension of opening 41a′, which corresponds basically to the area 3 of the package material blank. In FIG. 6, the package material blank 1 is arranged between the two molds half covering the recess 43a of second mold half and opening 41a′ of the first mold half 6A. Both mold halves and the package material blank 1 are arranged opposite each other in such way that opening 41a′ faces the recess 43 separated by the penetration area 3 of package material blank 1.

After the mold are placed on the package material blank the hot melt 71 is injected into the recess 43a at high pressure penetrating through the package material blank in area 3 and filling cavity 42a. The two halves are then removed after the molt is hardened. The first mold half is moved in vertical direction VD downwards, while spacer 61 remains in place between the package material blank the and the newly formed grip portion. The second mold half is moved upwards. The package material blank 1 is then moved sideward, for example in longitudinal direction LD. By doing so the spacer 61 is withdrawn from the space between grip portion and package material blank forming the displaced grip portion.

FIG. 7 illustrates the various method steps for manufacturing an opening device according to the present invention. In Step S1 the package material is moved between the two mold halves. The package material blank comprises a multilayer material structure having a layer of cellulosic material, one or more layers of plastic laminate and a penetration area. In step S2, the first mold half comprising the cavity with an opening on a first side of the package material blank. Said cavity is formed by moving a spacer portion relatively to a recess portion to partly cover a recess in the recess portion. The spacer portion is arranged such that it forms a coplanar surface with the surface of the recess portion 6A facing the package material blank. An area of the opening facing the package material blank is smaller than a projection of an area of the cavity onto the blank.

In accordance with step S3, a second mold half with a mold recess is then arranged on the other side of the package material blank, whereby the opening area partly overlaps the recess of the second mold half mold half recess in said penetration area.

The plastic mold is injected in step S4 into the recess or the cavity, for example it is injected into the recess at high pressures, thereby penetrating through the material in the overlapping areas. The hot melt fills the cavity and the recess and is at least partly hardened subsequently to form the opening device.

In step S5, the cavity is opened to release the grip portion and the grip portion is removed. The opening can be achieved in reversed order as step S3 and S2, respectively. For instance, the recess portion may be moved downwards away from the package material blank, while the spacer is kept facing the package material plank. To remove the grip portion, the package material blank may be moved in a longitudinal direction.

### REFERENCE LIST

1 package material blank
1A package material blank
2 consumer opening area
21 perforation
3 penetration area
4 opening device
40 material bridge
41 first portion
41a distal end
41a′ opening
41b proximal end
42 grip portion
42a cavity
43 second portion
43a recess
5 package
51 transversal seal
52 longitudinal seal
54 flap
6 second mold half
6A first mold half
6B recess portion
60 space
60A surface
61 spacer
610 surface
70 cone
71 hot melt
72 nozzle
73 channel
F focal center
D distance

1. Package material blank comprising a multilayer material structure having a layer of cellulosic material and one or more layers of plastic laminate, the package material blank comprising:
a first side and a second side opposite the first side and an penetration area;
a plastic opening device, the plastic opening device comprising:
a first portion on the first side having a proximal end adjacent to the first side and a distal end displaced from the first side;
a second portion attached to the second side;
a material bridge penetrating through the package material blank in the penetration area connecting the proximal end to the second portion;
a grip portion for a consumer to grab and by pulling the grip portion rupturing the package material blank;
wherein the grip portion is attached to the distal end of the first portion and displaced from the first side of the package material blank.

2. The package material blank according to claim 1, wherein the grip portion comprises an elongated part, which extends at least partial substantially parallel to the first side.

3. The package material blank according to claim 1, wherein a surface of the distal end to which the grip portion is attached to is substantial perpendicular to the first side.

4. The package material blank according to claim 1, wherein the first portion protrudes from the proximal end on the first side to the distal end in a curved shape.

5. The package according to claim 4, wherein a focus point of the curved shape lies in a space between the first side and the grip portion.

6. The package material blank according to claim 1, wherein the first portion protrudes linearly from the proximal end on the first side to the distal end.

7. The package material blank according to claim 1, wherein a projection of the distal end towards the first side is within the penetration area.

8. The package material blank according to claim 1, wherein the penetration area comprises at least one of:
an area larger than an area covered by the material bridge;
a substantial circular shape;
a substantial rectangular shape;
multilayer material structure having at least one layer less, than the multilayer material structure of the surrounding area, particularly lacking the layer of cellulosic material;
a smaller vertical dimension than an area of the package material blank surrounding the penetration area.

9. The package material blank according to claim 1, wherein the second portion on the second side extends beyond the penetration area.

10. The package material blank according to claim 1, further comprising
a consumer opening area, wherein said package material blank is ruptured in a defined manner on using the plastic opening device to open the consumer opening area.

11. The package material blank according to claim 10, wherein the consumer opening area comprises at least one of the following:
at least partly a line of weakness as to rupture the package material blank in a defined manner along said line of weakness.
at least partly the penetration area.

12. Package container for liquid food product comprising the package material blank according to claim 1.

13. A method for manufacturing an opening device, comprising the step of:
providing a package material blank with a multilayer material structure having a layer of cellulosic material, one or more layers of plastic laminate and a penetration area;
arranging a first mold half comprising a cavity with an opening on a first side of the package material blank, wherein an area of the opening facing the first side is smaller than a projection of an area of the cavity onto the first side;
arranging a second mold half comprising a mold recess on a second side package material blank opposing the first side, wherein the opening partly overlaps the second mold half recess in said penetration area;
injecting a plastic melt into at least one of said cavity and said recess, wherein the melt, due to pressure being built up in said cavity or said recess, penetrates through penetration area and fills also at least said recess and cavity thereby forming an opening device;
generating a grip portion of said opening device in said cavity using the injected plastic melt;
opening the cavity of said first mold half to release said grip portion;
remove the said grip portion from said cavity by relatively moving the first mold half and the package material blank.

14. The method of claim 13, wherein the step of opening the cavity comprises
moving the second mold half and the package material blank relative to each other in a direction perpendicular to the package material blank;
separating the first mold half into a spacer portion and a recess portion, by moving the recess portion relative to the package material blank and the spacer portion in a direction perpendicular to the package material and the spacer portion, wherein the spacer portion is arranged between the package material blank and the grip portion;
moving the spacer portion relative to the grip portion in a direction substantially parallel to the first side as to withdraw the spacer portion between the grip portion and the first side.

15. The method of claim 1, wherein arranging the first mold half comprises
providing a half mold portion having a recess;
providing a spacer portion partly covering the recess as to form a cavity having an opening, wherein the lid potion is relatively movable to the recess portion in a direction perpendicular to a plane substantially parallel to a surface of the spacer portion facing the first side;
arranging the spacer portion in the recess as to from a planar surface of the first mold half, said planar surface facing the first side.
